(19) United States
(12) Patent Application Publication
(10) Pub. No.: US 2017/0363279 A1
(43) Pub. Date: Dec. 21, 2017

(54) Luminous Attire

(71) Applicant: Jorge Roberto Macias, San Dimas, CA (US)

(72) Inventor: Jorge Roberto Macias, San Dimas, CA (US)

(21) Appl. No.: 15/186,491

(22) Filed: Jun. 19, 2016

(51) Int. Cl. F21V 33/00; F21V 23/04; F21V 21/088; F21V 21/08; A42B 1/24; A41D 19/00; A41D 1/08; A41D 1/00; A43B 3/00; A41B 1/00; F21W 111/10

(52) U.S. Cl. CPC F21V 33/0008; A43B 3/001; F21V 23/04; F21V 21/088; F21V 21/0832; A41B 1/00; A42B 1/244; A41D 19/0024; A41D 1/08; A41D 1/002; F21W 2111/10

(57) ABSTRACT

A luminous attire comprising a garment including at least one light source whereby when the luminous garment is worn by a user and in use, the at least one light source emits light in a direction substantially ahead of the wearer and in the direction in which the wearer is traveling to lighten the surroundings and direction in which the wearer is traveling. On the luminous garment, the at least one light source is positioned on the attire at at least one location whereby the wearer does not have to manually point the at least one light source ahead of the wearer and in the direction in which the wearer is traveling. The luminous attire may comprise different types of luminous garments. The wearer may simultaneously wear more than one type of luminous garment, if so desired.

### FIELD OF THE DISCLOSURE

Traditionally, lighted or luminous attire is generally one of two types. In a first type of luminous attire, the lighting of the illuminated attire purely provides a decorative effect. In a second type of luminous attire, the lighting of the luminous attire purely provides a short-range utility effect. For example, low intensity, non-directional light sources may be associated with some type of attire and used solely for aesthetic (decorative) or short-range lighting (lighting dark confined areas in which a worker is working or for directing nearby traffic in the dark) reasons. However, lighted or illuminated or luminous attire with other types of light sources can be used for other, more utilitarian, reasons.

Therefore, there is room for improvement within the art.

### BRIEF DESCRIPTION OF THE DRAWINGS

FIG. 1 is a first exemplary depiction of the luminous attire as described herein in use.

FIG. 2 is a second exemplary depiction of the luminous attire as described herein in use.

FIG. 3 is a third exemplary depiction of the luminous attire as described herein in use.

FIG. 4A is an exemplary luminous attire/luminous garment in the form of a glove and viewed from a first perspective.

FIG. 4B is an exemplary luminous attire/luminous garment in the form of a glove and viewed from a second perspective.

FIG. 5 is an exemplary luminous attire/luminous garment in the form of at least a partial leg covering.

FIG. 6 is an exemplary luminous attire/luminous garment in the form of a shoe.

FIG. 7A and FIG. 7B are exemplary luminous attire/luminous garment in the form of upper body garments.

FIG. 8 is an exemplary luminous attire/luminous garment in the form of a hat.

FIG. 9 is an exemplary attachable/removable light source and light circuit for use with a luminous attire/garment in the form of a glove.

FIG. 10A, FIG. 10B is an exemplary attachable/removable light source and light circuit for use with a luminous attire/garment in the form of a sleeve or pant leg.

FIG. 11 is an exemplary attachable/removable light source and light circuit for use with a luminous attire/garment in the form of a shoe.

FIG. 12 is an exemplary attachable/removable light source and light circuit for use with a luminous attire/garment in the form of a hat.

### DETAILED DESCRIPTION OF THE DRAWINGS

It will be appreciated that for simplicity and clarity of illustration, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure. Similar reference numerals are used to refer to structures similar to the various exemplary embodiments.

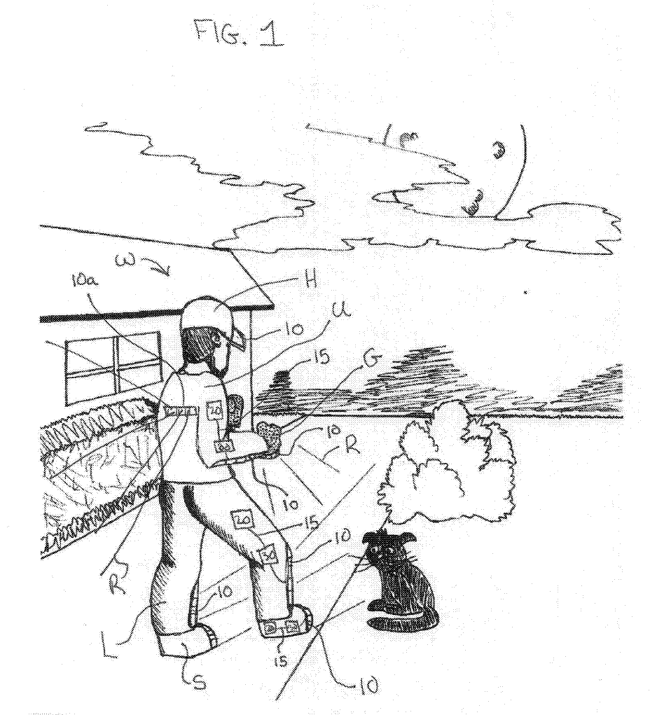

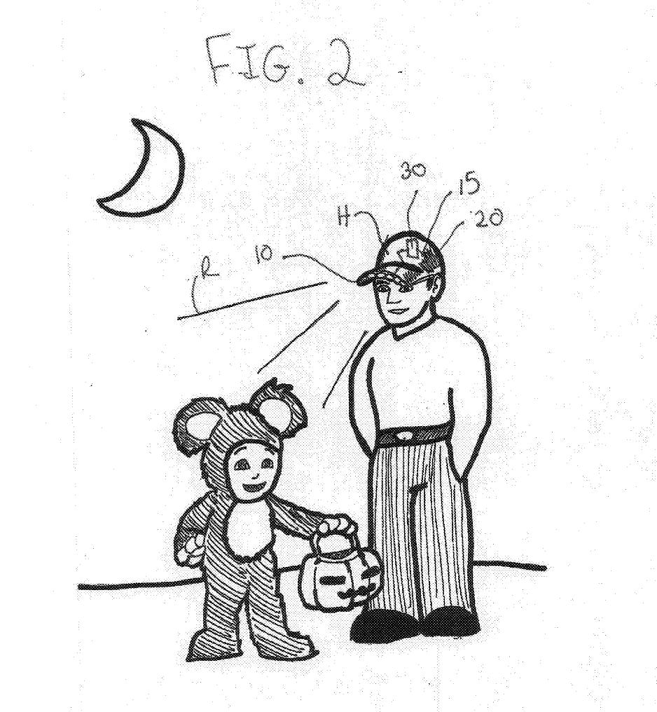

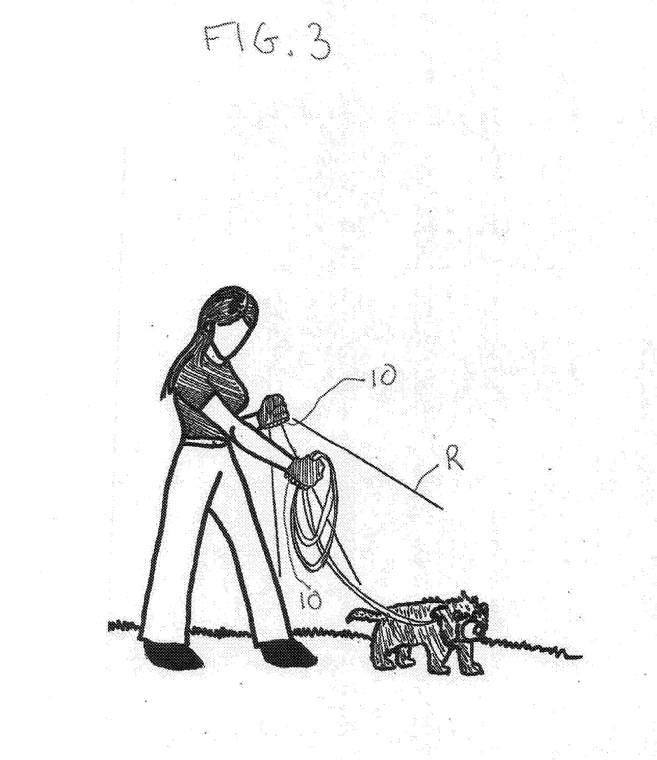

FIG. 1, FIG. 2 and FIG. 3 depict various exemplary types of luminous attire in exemplary uses.

The luminous attire according to the various exemplary types generally comprises at least one light source 10, whereby when the luminous attire is worn by a wearer W and in use, the light source 10 emits light rays R substantially ahead of the wearer W and in the direction in which the wearer W is traveling to lighten the surroundings and direction in which the wearer W is traveling. The light sources 10 emit lights rays R extending well beyond the immediate area of the light source 10. This distinguishes the luminous attire described herein with prior art decoratively lighted attire or lighted utility/work garments, such as gloves, which only light the immediate area in front of the attire. For example, according to the exemplary embodiments of the present disclosure, using a high intensity directional light source, the emitted light may extend at least about 5-10 feet or at least about 2-4 car lengths in front of the wearer W.

According to the exemplary embodiments and for the wearer's convenience, the light sources 10 are positioned on the luminous attire at at least one location whereby the wearer W does not have to manually point the light source ahead of the wearer W and in the direction in which the wearer W is traveling.

The luminous attire may comprise one or more individual light sources 10 on one or more different types of luminous garments. Each type of luminous garment will typically include a light circuit including a power source 20 and switch 30. Wire(s) 15 can electrically connect the light source 10, power source 20, and switch 30. Power source 20 power the luminous attire's light sources 10. The power source 20 may comprise, for example, a battery. Alternatively, instead of a battery, the power source 20 may comprise a power generator (not shown) that creates electric power in response to motion of the wearer W. Further alternatively, power source 20 may comprise a solar cell/battery that charges the battery during the daytime for powering the light source in the dark. Switch 30, for example in the form of a manual or motion-activated switch, may be provided for turning the luminous attire's light sources 10 “on” and “off”. The wires 15 for the light circuit may be either positioned on the surface of the luminous garment or sewn into the luminous garment itself. Wires 15 may be omitted in situations where the luminous garment is made from a material that is electrically conductive.

As previously mentioned, the luminous attire may comprise different types of luminous garments. While in FIG. 1, the wearer W is shown simultaneously wearing more than one type of luminous garment, the disclosure is not so limited and the wearer W may wear one or more types of luminous garment, if so desired (FIG. 2 or FIG. 3).

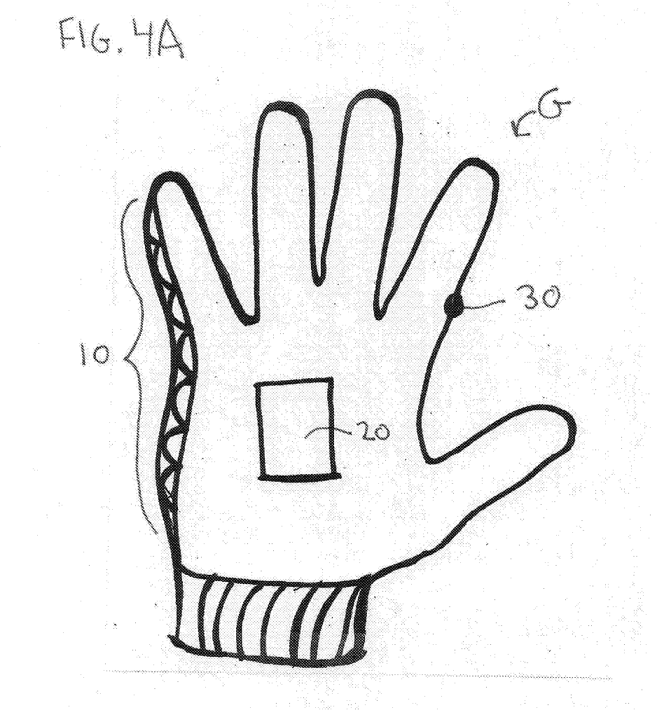

A first exemplary luminous garment may comprise a glove G, as shown in FIG. 4A and FIG. 4B, and the light sources 10 on glove G are positioned on the glove at a position whereby during a normal jogging, walking, or running stride, the light source 10 points and emits light in a direction substantially ahead of the wearer W and in the direction in which the wearer W is traveling. This position is typically in line with and adjacent to the pinky sides of the wearer's hands. The location of power source 20 and switch 30 may be in any convenient position and wires 15 are not shown for simplicity or to exemplify when the garment material is electrically conductive.

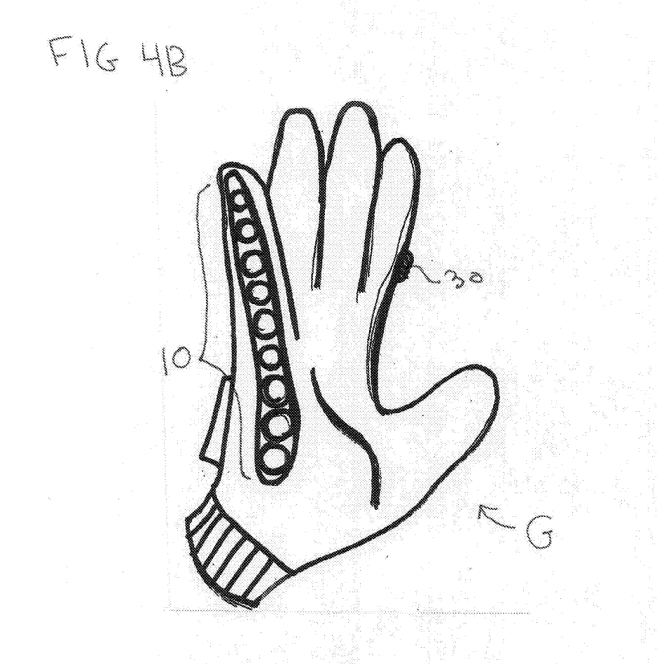

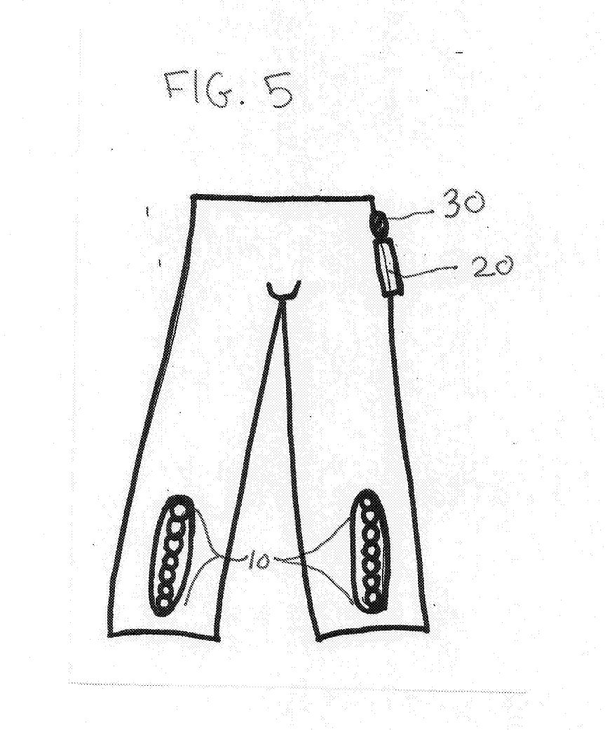

A second exemplary luminous garment may comprise at least a partial leg covering, as shown in FIG. 5. The light source 10 is positioned on the at least partial leg covering L at a position, such as the front of the leg, whereby during a normal jogging, walking, or running stride, the light source 10 points and emits light in a direction substantially ahead of the wearer W and in the direction in which the wearer W is traveling. For example, the at least partial leg covering may comprise pants, shorts, jogging pants, bicycle shorts, skirt, dress, or the like. The location of power source 20 and switch 30 may be in any convenient position and wires 15 are not shown for simplicity or to exemplify when the garment material is electrically conductive.

A third exemplary luminous garment may comprise a shoe S, as shown in FIG. 6. The light source 10 is positioned on the shoe at a position whereby during a normal jogging, walking, or running stride, the light source 10 points and emits light in a direction substantially ahead of the wearer W and in the direction in which the wearer W is traveling. For example, the light source 10 may be typically positioned on a front edge of the shoe and facing the direction in which the wearer W is traveling. In other words, the light source 10 is positioned on an outside front of the shoe substantially in line with and adjacent to the adjacent the front tips of the wearer's toes and facing the direction in which the wearer W is traveling. The location of power source 20 and switch 30 may be in any convenient position and wires 15 are not shown for simplicity or to exemplify when the garment material is electrically conductive.

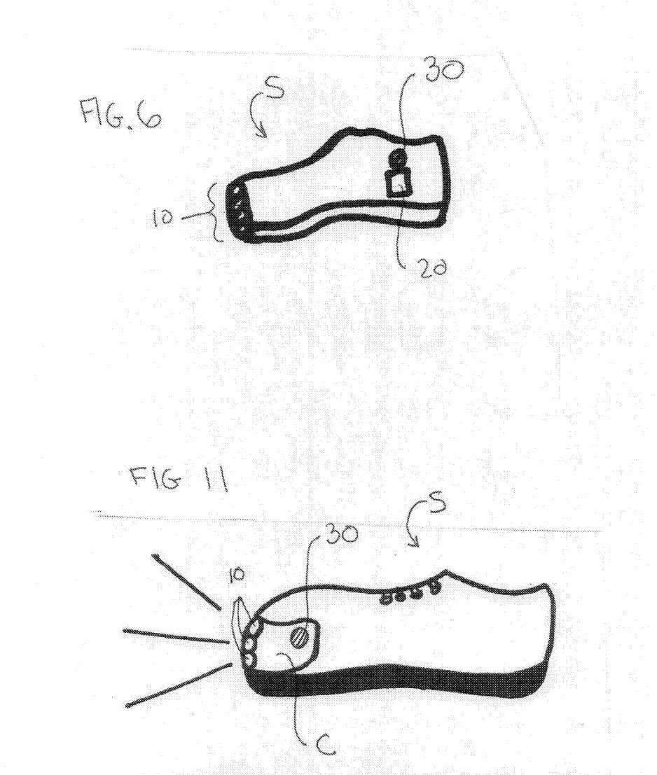

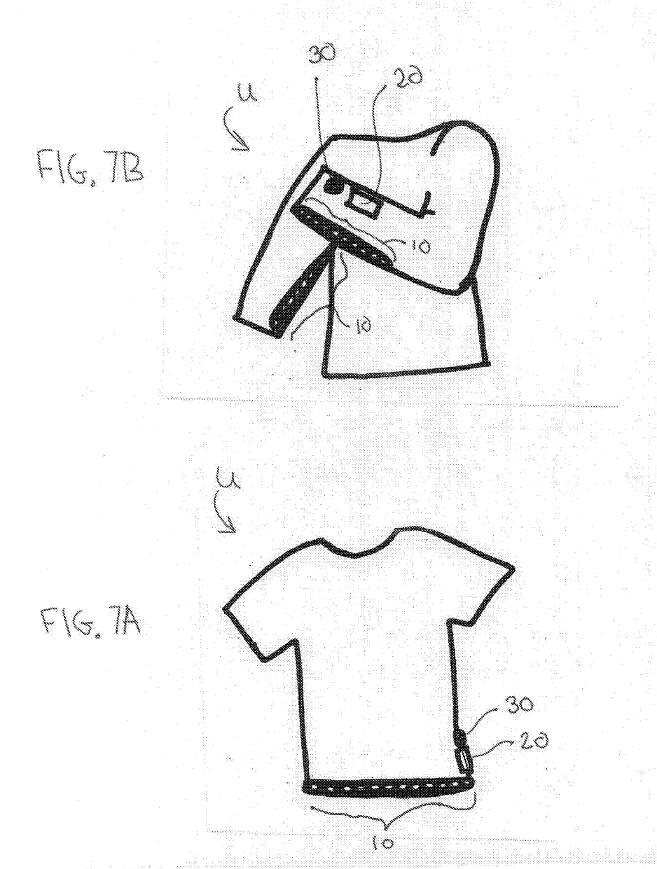

A fourth exemplary luminous garment may comprise an upper body garment U, as shown in FIG. 7A and FIG. 7B. The light source 10 is positioned on the upper body garment U at a position whereby during a normal jogging, walking, or running stride, the light source 10 points and emits light in a direction substantially ahead of the wearer W and in the direction in which the wearer W is traveling. The upper body garment may comprise a shirt, a jersey, a sweater, a sweatshirt, a blouse, a vest, or the like. In a first exemplary embodiment, as shown in FIG. 7A, the light source 10 may be located toward the lowermost edge of the garment. In a second exemplary embodiment, as shown in FIG. 7B, the light source 10 may be located on the sleeves of the garment. The location of power source 20 and switch 30 may be in any convenient position and wires 15 are not shown for simplicity or to exemplify when the garment material is electrically conductive.

A fifth exemplary luminous garment may comprise a hat H, as shown in FIG. 8. The light source 10 is positioned on the hat H a position whereby during a normal jogging, walking, or running stride, the light source 10 points and emits light in a direction substantially ahead of the wearer W and in the direction in which the wearer W is traveling. The light source 10 may be positioned on the front of the hat brim or any other convenient position, so long as the light source 10 points and emits light in a direction substantially ahead of the wearer W and in the direction in which the wearer W is traveling. The location of power source 20 and switch 30 may be in any convenient position and wires 15 are not shown for simplicity or to exemplify when the garment material is electrically conductive.

In the various exemplary luminous garments described herein, the light source 10 may comprise one or more uni-directional light emitting diodes (LED) that point and emit light that lightens the surroundings and direction in which the wearer W is traveling. While the exemplary embodiments are described with reference to light sources 10 being LEDS, any light source may be used.

Additionally, as shown in FIG. 1, the luminous attire may further comprise another light source 10a positioned on the luminous garment at a position where the light source 10a emits light in a direction other than the direction in which the wearer W is traveling. For example, the light emitted may serve to warn others of the presence of the wearer W. The direction other than the direction in which the wearer W is traveling will generally be the direction opposite to the direction in which the wearer W is traveling. The location of power source 20 and switch 30 may be in any convenient position and wires 15 are not shown for simplicity or to exemplify when the garment material is electrically conductive.

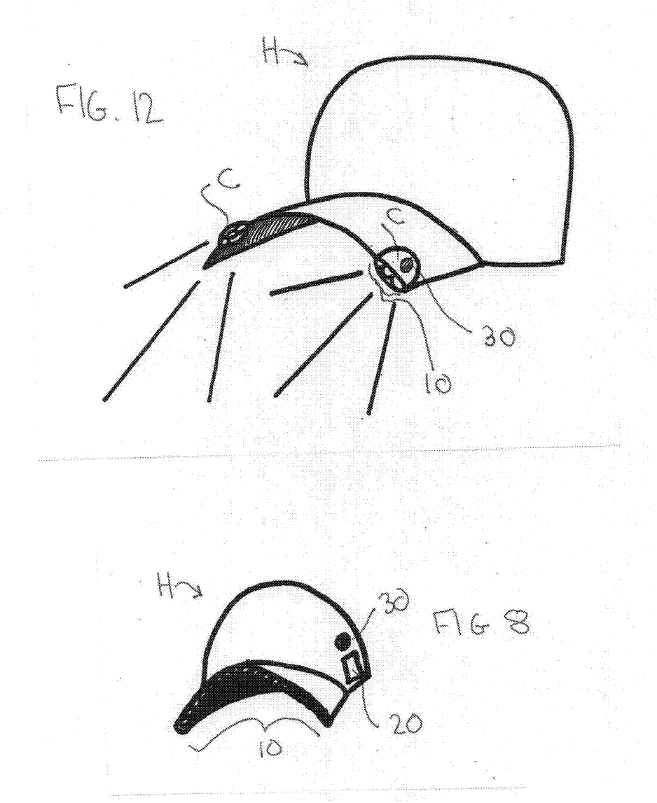

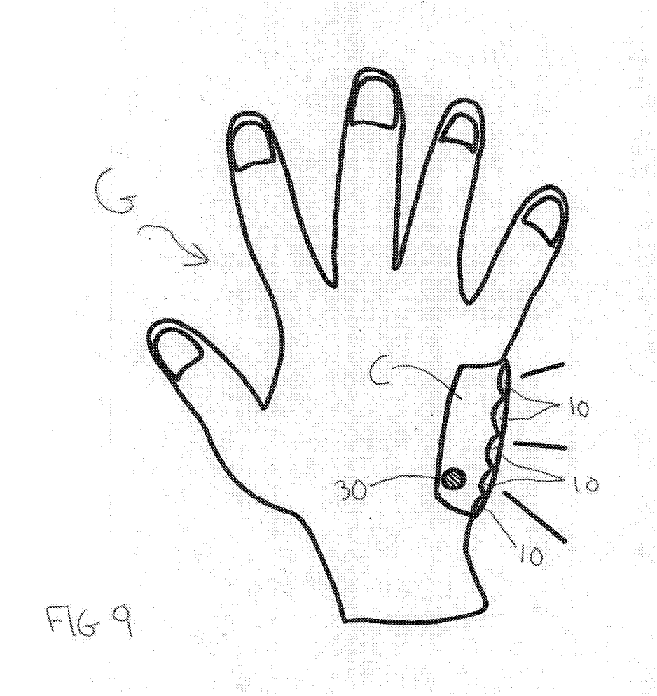

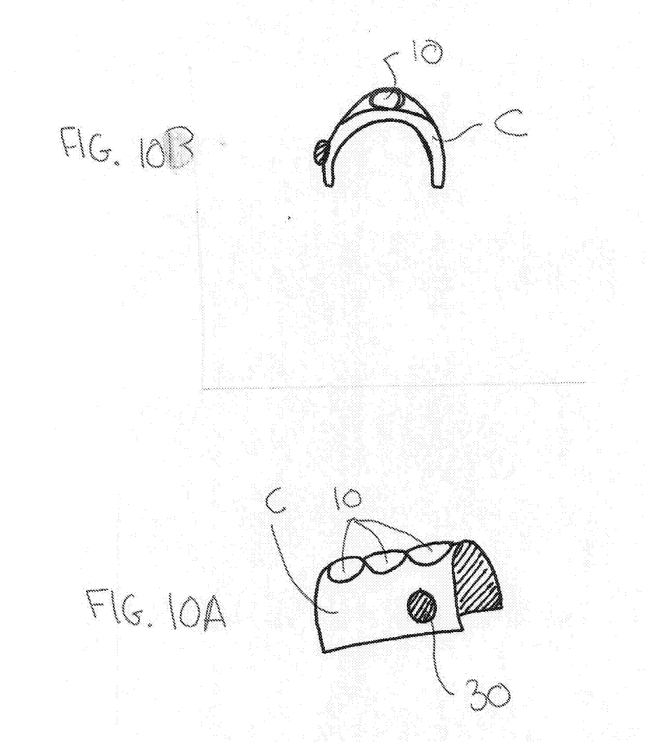

The construction of the luminous garment may comprise a number of different methods. For example, an alternative embodiment may be one in which the light source 10 is not integral with the luminous garment and may be removed without damage to the luminous garment and only associated with the garment when the light functionality is required. For example, as shown in FIGS. 9, 10A, 10B, 11, 12, the light source 10 and light circuit may be part of a separate clip-on or otherwise (e.g. Velcro) attachable and removable to the garment structure C (power sources 20 not show, for simplicity).

Or, for example, a second construction may be one in which the light source 10 is integral with the luminous garment and may be removed with damage to the luminous garment.

The embodiments shown and described above are only examples. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in decorative and structural matters of shape, size and arrangement of the parts within the principles of the present disclosure up to, and including the full extent established by the broad general meaning of the terms used in the claims. It will therefore be appreciated that the embodiments described above may be modified within the scope of the claims.

That which is claimed:

1. A luminous attire comprising a garment including at least one light source whereby when the luminous garment is worn by a user and in use, the at least one light source emits light in a direction substantially ahead of the wearer and in the direction in which the wearer is traveling to lighten the surroundings and direction in which the wearer is traveling.

2. The luminous attire of claim 1, whereby the emitted light extends well beyond the immediate area of the at least one light source.

3. The luminous attire of claim 2, whereby the emitted light extends at least about 5-10 feet in front of the wearer.

4. The luminous attire of claim 2, whereby the emitted light extends at least about 2-4 car lengths in front of the wearer.

5. The luminous attire of claim 1, whereby the at least one light source is positioned on the garment at at least one location whereby the wearer does not have to manually point the at least one light source ahead of the wearer and in the direction in which the wearer is traveling.

6. The luminous attire of claim 1, whereby the at least one light source comprises:
a plurality of light sources;
a power source for powering the at least one light sources; and
a switch for turning the at least one light sources on and off.

7. The luminous attire of claim 1, whereby the luminous garment comprises a glove and the at least one light source is positioned on the glove at a position whereby during a normal jogging, walking, or running stride, the at least one light source points and emits light in a direction substantially ahead of the wearer and in the direction in which the wearer is traveling.

8. The luminous attire of claim 1, whereby the luminous garment comprises at least a partial leg covering and the at least one light source is positioned on the at least partial leg covering at a position whereby during a normal jogging, walking, or running stride, the at least one light source points and emits light in a direction substantially ahead of the wearer and in the direction in which the wearer is traveling.

9. The luminous attire of claim 8, whereby the at least partial leg covering comprises pants, shorts, jogging pants, bicycle shorts, skirt, dress, or the like.

10. The luminous attire of claim 1, whereby the luminous attire comprises a shoe and the at least one light source is positioned on the shoe at a position whereby during a normal jogging, walking, or running stride, the at least one light source points and emits light in a direction substantially ahead of the wearer and in the direction in which the wearer is traveling.

11. The luminous attire of claim 10, whereby the at least one light source is positioned on a front of the shoe and facing the direction in which the wearer is traveling.

12. The luminous attire of claim 10, whereby the at least one light source is positioned on an outside front of the shoe substantially in line with and adjacent to the adjacent the front tips of the wearer's toes and facing the direction in which the wearer is traveling.

13. The luminous attire of claim 1, whereby the luminous garment comprises an upper body garment and the at least one light source is positioned on the upper body garment at a position whereby during a normal jogging, walking, or running stride, the at least one light source points and emits light in a direction substantially ahead of the wearer and in the direction in which the wearer is traveling.

14. The luminous attire of claim 13, whereby the upper body garment comprises: a shirt, a jersey, a sweater, a sweatshirt, a blouse, a vest, or the like.

15. The luminous attire of claim 1, whereby the luminous garment comprises a hat and the at least one light source is positioned on the hat at a position whereby during a normal jogging, walking, or running stride, the at least one light source points and emits light in a direction substantially ahead of the wearer and in the direction in which the wearer is traveling.

16. The luminous attire of claim 1, whereby the at least one light source comprises a unidirectional LED that points and emits light in the direction in which the wearer is traveling.

17. The luminous attire of claim 1, whereby the at least one light source comprises a plurality of light sources that point and emit light in the direction in which the wearer is traveling.

18. The luminous attire of claim 1, further comprising another light source positioned on the luminous attire at a position whereby the another light source emits light in a direction other than the direction in which the wearer is traveling to warn others of the presence of the wearer.

19. The luminous attire of claim 18, whereby the direction other than the direction in which the wearer is travelling is the direction opposite to the direction in which the wearer is traveling.

20. The luminous attire of claim 1, whereby the at least one light source is a separate attachable/removable light source and light circuit structure that can be removed from the luminous attire without damage to the luminous attire.

21. The luminous attire of claim 1, whereby the at least one light source is integral with the luminous attire and may be removed with damage to the luminous attire.
